(19) United States
(12) Patent Application Publication
(10) Pub. No.: US 2022/0329174 A1
(43) Pub. Date: Oct. 13, 2022

(54) ELECTRICAL DEVICE AND POWER CONVERTER ASSEMBLY

(71) Applicant: Siemens Energy Global GmbH & Co. KG, Muenchen (DE)

(72) Inventors: David Doering, Hoppegarten (DE); Guenter Ebner, Henfenfeld (DE); Gerald Franz Giering, Kalchreuth (DE); Klaus Wuerflinger, Nuernberg (DE); Marcus Zeller, Erlangen (DE)

(21) Appl. No.: 17/765,858

(22) PCT Filed: Oct. 1, 2019
(86) PCT No.: PCT/EP2019/076621

§ 371 Date: Apr. 1, 2022

(51) Int. Cl. H02M 7/00

(52) U.S. Cl. CPC H02M 7/003

(57) ABSTRACT

An electric high-voltage device includes a fluid-tight housing, a high-voltage component arranged in the housing, and an insulating liquid in the housing in order to electrically insulate the high-voltage component. The high-voltage component is a passive current collector which is configured to at least temporarily conduct a current of at least 1 kA. There is also described a power converter assembly with the high-voltage device.

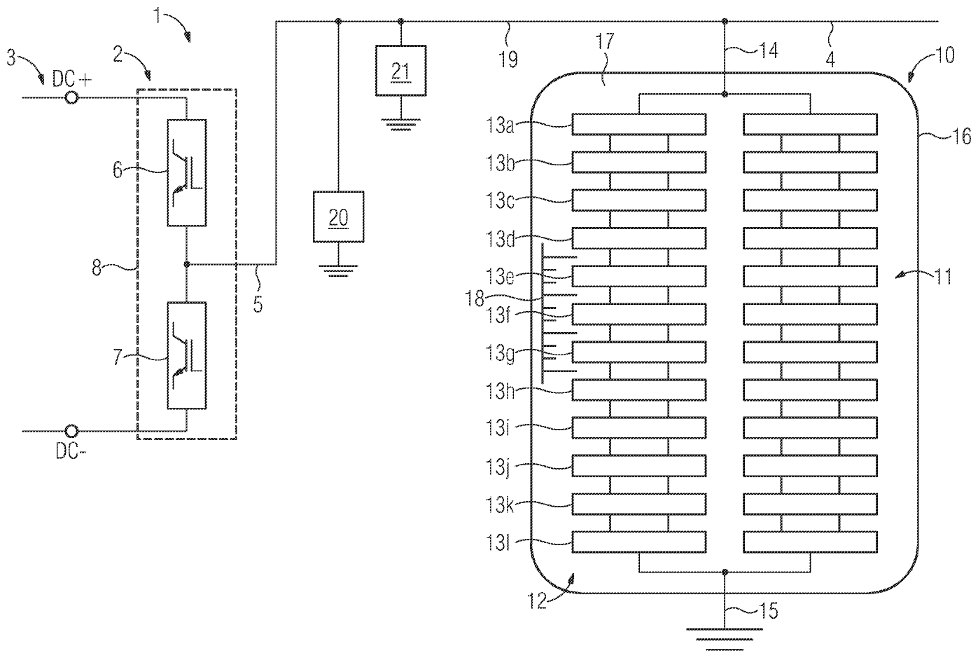

The invention relates to an electrical high-voltage device comprising a fluid-tight housing, a high-voltage component, which is arranged in the housing, and an insulating liquid in the housing for electrically insulating the high-voltage component.

In high-voltage technology, generally high-voltage devices have to satisfy high insulation requirements in order to ensure the safety of the installation. In the case of a conventional placement in the open air, the high voltages during operation of the high-voltage device accordingly result in high demands on the physical distances. The surface-area requirement associated therewith is an important cost factor.

WO 2019/101288 A1 discloses a power converter assembly in which the power converter valves of the power converter assembly are arranged in fluid-tight encapsulating housings and are electrically insulated by means of an insulating fluid. A disadvantage of this known solution, however, is the poor accessibility to components of the power converter valves, for example in the event of maintenance.

It is therefore the object of the invention to specify a high-voltage device of the generic type in which the fluid insulation is as efficient as possible and the most reliable possible operation of the high-voltage device is made possible.

In the case of a high-voltage device of the generic type, the object is achieved in accordance with the invention by virtue of the fact that the high-voltage component is a passive current collector apparatus, which is set up to conduct at least temporarily a current of at least 1 kA. Passive current collector apparatuses are used in high-voltage installations to conduct or conduct away the, in some instances, high currents, for example in the event of a fault. In this case, it may be filter apparatuses, braking apparatuses or arresters that are involved, for example. A current collector apparatus is distinguished in particular in that high heat losses arise at the current collector apparatus on account of the function thereof. In particular, a current collector apparatus can be set up to conduct (at least temporarily) currents far above 1 kA, suitably even above 10 kA, such that the generation of heat in some circumstances is huge. Taking this circumstance into account, the liquid insulation of the high-voltage component permits not only a compact design but at the same time particularly efficient cooling of the high-voltage component using the liquid insulation. Furthermore, the high-voltage device according to the invention has the advantage over gas-insulated installations that it is possible to omit the SF6 gas conventionally used therein, which is known to be damaging to the environment.

The current collector apparatus is considered to be passive when the components that discharge or conduct away the current operate without the need for a control system. Passive components are relatively low-maintenance, such that the liquid-insulated encapsulation thereof does not constitute a significant disadvantage in the context of maintenance. A further advantage results from a significantly reduced recooling time, which makes much more rapid resumption of the regular operation of the high-voltage device after loading by the current collection system possible.

In order to configure the cooling of the high-voltage component particularly effectively, it is considered to be advantageous if the high-voltage component is completely surrounded by the insulating liquid (up to lines and the like possibly emerging from the housing).

The insulating liquid is preferably an ester, particularly preferably a synthetic ester. An example of this is pentaerythritol tetra fatty acid ester. Esters have a very good insulation capability. Esters also have a high heat capacity, such that the advantageous cooling effect can be achieved particularly well. At the same time, esters have an extremely good biodegradability. Such materials therefore also have advantages in terms of aging phenomena (possibly leakage of the housing in long-term operation).

According to one embodiment of the invention, the high-voltage component is a high-voltage arrester for discharging currents of at least 1 kA, wherein the high-voltage arrester is expediently set up to discharge currents of at least 10 kA depending on the application. The high-voltage arrester is usually used to ensure voltage limitation of a connected high-voltage installation in the event of an overvoltage. During operation, the high-voltage arrester conducts a high current in a short time and thus is subjected to a correspondingly high energy input. In addition, under some circumstances, a leakage current of significantly less than 1 A, for example in the range of a few microamperes to milliamperes, can even lead to an increased operating temperature of the high-voltage arrester. A longer application of a measurement voltage can lead to the arrester no longer being able to cool, but instead becoming thermally unstable and heating up further to the point of self-destruction. However, this heat can advantageously be taken up and dissipated by means of the liquid insulation, such that the described disadvantages do not arise or higher quiescent currents are made possible. This results in both more flexible coordinations of all of the arresters of a system, for example staggering of the intervention of different arrester stages, and an expanded spectrum of use, since longer-running uses can also be included.

The high-voltage arrester is preferably a metal oxide arrester or varistor, which expediently comprises ZnO and/or SiC elements.

The high-voltage arrester preferably comprises discharge disks, which are arranged in a tensioning brace that mechanically and electrically connects the discharge disks to one another. This arrangement permits particularly high currents to be conducted away. The generation of heat by such an arrester is therefore particularly high.

According to one embodiment of the invention, the high-voltage component is a passive filter or a braking apparatus, comprising braking resistors. The braking apparatus is expediently used for conducting an excess amount of energy away from a high-voltage system in a targeted manner in order to counteract a voltage increase. The braking apparatus can be connected to the high-voltage system or bypassed, for example by means of suitable switching apparatuses. The passive filter may comprise, for example, capacitive components such as capacitors and/or inductive components such as inductors.

With respect to further optimization of the high-voltage device and the cooling and compact design thereof, the high-voltage device comprises a plurality of high-voltage components, which are electrically connected in parallel and which are arranged together in the housing. In the case of components connected in parallel, an identical voltage drops at each of said components, such that the dimensions of the housing in respect of insulation distances do not have to be increased significantly with respect to the accommodation of an individual high-voltage component. For example, a plurality of discharge columns (in each case resistance elements arranged in a tensioning brace) can be arranged in a common housing, which further reduces the space requirement of the high-voltage device.

The insulating liquid is preferably not circulated during operation of the high-voltage device. This means that the high-voltage device is not provided with active circulation of the insulating liquid by means of appropriate apparatuses.

Circulation of the insulating liquid on account of independent convection movement is not excluded, however. In this way, a simplified construction of the high-voltage device is advantageously made possible.

According to one embodiment of the invention, the high-voltage device comprises a heat sink, which is arranged in the housing. The heat sink makes it possible to further improve the cooling effect. At the same time, the simplicity of the construction is not waived if the heat sink operates purely passively. The heat sink is suitably designed in such a way that it improves the energy output to the insulating liquid, for example by way of suitable ribs or channels.

At least one liquid-insulated line is expediently provided, by means of which the high-voltage component is able to be connected to electrical devices outside of the housing. An exchange of heat between the devices is advantageously made possible in this way.

The housing preferably comprises fiber-reinforced plastic. A stable and at the same time electrically insulating housing is provided in this way.

The invention furthermore relates to a power converter assembly having a power converter, which comprises power converter valves, which are each arranged in a separate liquid-tight housing, which is filled with an insulating liquid.

A power converter assembly of this kind is known from WO 2019/101288 A1, already mentioned above.

The object of the invention consists in proposing a power converter assembly of the generic type that is as reliable and cost-effective as possible.

In the case of a power converter assembly of the generic type, the object is achieved by virtue of the fact that the power converter assembly also comprises a high-voltage device according to the invention.

The advantages of the power converter assembly according to the invention result, in particular, from the advantages of the high-voltage device according to the invention that have been explained above.

The invention is explained in more detail below based on an exemplary embodiment, illustrated in the FIGURE.

The FIGURE shows a schematic illustration of an exemplary embodiment of a power converter assembly according to the invention having a high-voltage device according to the invention. The high-voltage range is understood here as the range of voltages above 1 kV occurring.

The FIGURE illustrates a power converter assembly 1. The power converter assembly 1 comprises a power converter 2, which is arranged between a DC voltage network 3 and an AC voltage network 4 during operation of the power converter assembly 1. The power converter 2 is connected to the DC voltage network 3 by means of DC voltage terminal connections DC+, DC- and to the AC voltage network by means of an AC voltage terminal connection 5. The power converter 2 comprises a first power converter valve 6 and a second power converter valves 7, wherein the first power converter valve 6 is arranged between the first DC voltage terminal connection DC+ and the AC voltage terminal connection 5 and the second power converter valve 7 is arranged between the second DC voltage pole DC- and the AC voltage terminal connection 5. The two power converter valves 6 and 7 each comprise controllable semiconductor switches that preferably can be switched off.

According to the example in the FIGURE, during operation of the power converter assembly 1, an AC voltage of more than 100 kV is applied to the AC voltage side of the power converter 2.

The power converter 2 comprises a fluid-tight, in particular liquid-tight housing 8. The two power converter valves 6, 7 are accommodated in the housing 8 such that they are completely surrounded by an insulating fluid (up to the lines that are led out of the housing).

The power converter assembly 1 also comprises a high-voltage device 10 having a high-voltage component in the form of a first high-voltage arrester 11. The high-voltage device 10 is arranged on the AC voltage side of the power converter 2 and is connected to the AC voltage network 4. The high-voltage device 10 also comprises a second high-voltage arrester 12, wherein the two high-voltage arresters 11, 12 have a similar construction in the example illustrated.

The first high-voltage arrester 11 comprises a series circuit of arrester elements in the form of discharge disks 13a-131, which are arranged with one another in a tensioning brace. The series circuit of arrester elements is connected between an AC voltage terminal connection 14 of the high-voltage device 10 and a ground terminal connection 15. The two high-voltage arresters 11 and 12 are connected in a parallel circuit between the AC voltage network 4 and ground.

The high-voltage device 10 also comprises a liquid-tight housing 16, in which the two high-voltage arresters 11 and 12 are arranged. The housing 16 is filled with an insulating liquid in the form of an ester liquid 17, which is additionally used to cool the high-voltage arresters 11, 12. In this case, the insulating liquid is operated without circulation, that is to say the high-voltage device 10 does not have an apparatus for actively moving the insulating liquid within the housing 16. A heat sink 18, which is also arranged in the housing 16, is provided for improved cooling of the high-voltage arrester 11 or transporting heat away therefrom.

The connection 19 between the AC voltage terminal connection 14 of the high-voltage device 10 and the AC voltage terminal connection 5 of the power converter 2 can also be embodied as a gas-insulated or liquid-insulated line.

The power converter assembly 1 also comprises a passive filter 20 and a braking apparatus 21 comprising braking resistors, which are each accommodated in encapsulated liquid-insulated housings, which are filled with an insulating ester liquid.

1-13. (canceled)

14. An electrical high-voltage device, comprising:
a fluid-tight housing;
a high-voltage component disposed in said housing, said high-voltage component being a passive current collector apparatus configured to conduct, at least temporarily, a current of at least 1 kA; and
an insulating liquid in said housing for electrically insulating said high-voltage component.

15. The high-voltage device according to claim 14, wherein said high-voltage component is completely surrounded by said insulating liquid.

16. The high-voltage device according to claim 14, wherein said insulating liquid is a synthetic ester.

17. The high-voltage device according to claim 14, wherein said high-voltage component is a high-voltage arrester for discharging currents of at least 1 kA.

18. The high-voltage device according to claim 17, wherein said high-voltage arrester is a metal oxide collector.

19. The high-voltage device according to claim 18, wherein said high-voltage arrester is a varistor comprising elements selected from the group consisting of ZnO and SiC.

20. The high-voltage device according to claim 18, wherein said high-voltage arrester comprises a plurality of discharge disks arranged in a tensioning brace.

21. The high-voltage device according to claim 14, wherein said high-voltage component is a passive filter or a braking apparatus comprising braking resistors.

22. The high-voltage device according to claim 14, wherein said high-voltage component is one of a plurality of high-voltage components, which are electrically connected in parallel and arranged together in said housing.

23. The high-voltage device according to claim 14, wherein said insulating liquid is not actively circulated.

24. The high-voltage device according to claim 14, further comprising a heat sink arranged in said housing.

25. The high-voltage device according to claim 14, further comprising at least one liquid-insulated line configured to connect said high-voltage component to electrical devices outside said housing.

26. The high-voltage device according to claim 14, wherein said housing comprises fiber-reinforced plastic.

27. A power converter assembly, comprising:
a power converter having a plurality of power converter valves, disposed in a separate liquid-tight housing, which is filled with an insulating liquid; and
at least one high-voltage device according to claim 14 electrically connected to said power converter valves.
